(19) United States
(12) Patent Application Publication
(10) Pub. No.: US 2016/0324365 A1
(43) Pub. Date: Nov. 10, 2016

(54) COFFEE MACHINE

(71) Applicant: Tsann Kuen (Zhangzhou) Enterprise Co., Ltd., Zhangzhou (CN)

(72) Inventors: Chungho Pan, Zhangzhou (CN); Xiaoxuan Mu, Zhanzhou (CN); Zhiqiang Xue, Zhangzhou (CN)

(73) Assignee: Tsann Kuen (Zhangzhou) Enterprise Co., Ltd., Zhangzhou (CN)

(21) Appl. No.: 15/142,701

(22) Filed: Apr. 29, 2016

(30) Foreign Application Priority Data
May 4, 2015 (CN) 201510219224.6

(51) Int. Cl. A47J 31/46

(52) U.S. Cl. CPC A47J 31/465

(57) ABSTRACT

A coffee machine includes a base, a driving unit, and a water supply unit. The base has a guiding wall, and a spiral guiding groove formed in the guiding wall and winding around a rotational axis. The driving unit includes a transmission gear rotatable about the rotational axis, and formed with a guiding hole that extends radially and outwardly from a center of the transmission gear and that is disposed above said spiral guiding groove. The water supply unit includes a water tube having a guiding section that extends through the guiding hole and the spiral guiding groove, and that is movable along the spiral guiding groove with the guidance of the guiding hole during rotation of the transmission gear about the rotational axis.

### CROSS-REFERENCE TO RELATED APPLICATION

This application claims priority of Chinese Application No. 201510219224.6, filed on May 4, 2015.

### FIELD

The disclosure relates to a coffee machine, and more particularly to an improvement of a brewing mechanism of the coffee machine.

### BACKGROUND

FIGS. 1 and 2 illustrate a conventional coffee machine 1 that is disclosed in Chinese Utility Model Patent Publication No. CN2810437Y. The conventional coffee machine 1 includes a base 11, a driving unit 12 mounted to the base 11, a water supply unit 13 mounted on the base 11, and a control circuit 14. The base 11 has a receiving space 111 located at a bottom portion thereof for accommodating a filter cup 10, and a guiding wall 112 disposed above the receiving space 111 and having a spiral guiding groove 113. The driving unit 12 includes a motor 121 mounted to the base 11, and a linear sliding unit 122 driven by the motor 121 and disposed between the filter cup 10 and the motor 121. The water supply unit 13 includes a tank 131 mounted on the base 11, a heater 132 disposed inside the tank 131, a first water tube 133 connected between the tank 131 and the heater 132, a first solenoid valve 134 connected to the first water tube 133, a dispensing tube 135 disposed under the linear sliding unit 122 and extending through the spiral guiding groove 113, a second water tube 136 connected between the dispensing tube 135 and the heater 132, and a second solenoid valve 137 connected to the second water tube 136. The first and second solenoid valves 134, 137 and the motor 121 are electrically connected to the control circuit 14.

In use, the filter cup 10 is firstly disposed under the guiding wall 112, and the first and second solenoid valves 134, 137 and the motor 121 are then controlled by the control circuit 14, such that water stored in the tank 131 flows into the heater 132 to be heated, and then flows to the dispensing tube 135 through the second water tube 136. At the same time, the linear sliding unit 122 is driven by the motor 121 to drive the dispensing tube 135 to move along the spiral guiding groove 113, thereby eventually brewing coffee.

However, the conventional coffee machine 1 has a relatively complicated structure and a high manufacturing cost. In addition, one end of the second water tube 136 is connected to the dispensing tube 135, such that the second water tube 136 maybe tangled during movement of the dispensing tube 135 along the spiral guiding groove 113, and be interfered or scratched by surrounding elements of the conventional coffee machine 1 during operation, thereby causing leakage of hot water.

### SUMMARY

Therefore, the object of the disclosure is to provide a coffee machine that has a simple structure, can be smoothly operated, and can increase safety in use.

According to the disclosure, the coffee machine includes a base, a driving unit, and a water supply unit. The base has a guiding wall, and a spiral guiding groove formed in the guiding wall and winding around a rotational axis. The driving unit includes a transmission gear rotatable about the rotational axis, and formed with a guiding hole that extends radially and outwardly from a center of the transmission gear and that is disposed above the spiral guiding groove. The water supply unit includes a water tube having a guiding section that extends through the guiding hole and the spiral guiding groove, and that is movable along the spiral guiding groove with the guidance of the guiding hole during rotation of the transmission gear about the rotational axis.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a conventional coffee machine disclosed in Chinese Utility Model Patent Publication Number No. CN2810437Y;

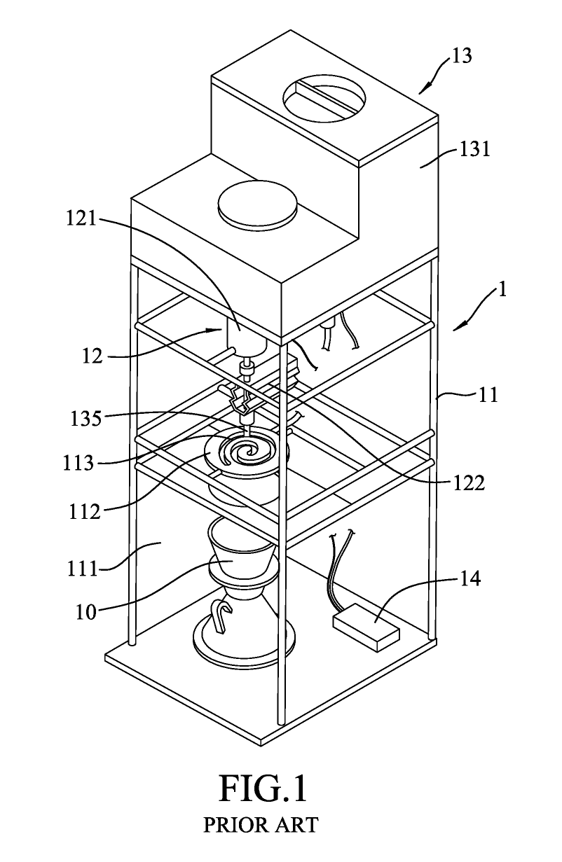

FIG. 2 is a side view of the conventional coffee machine;

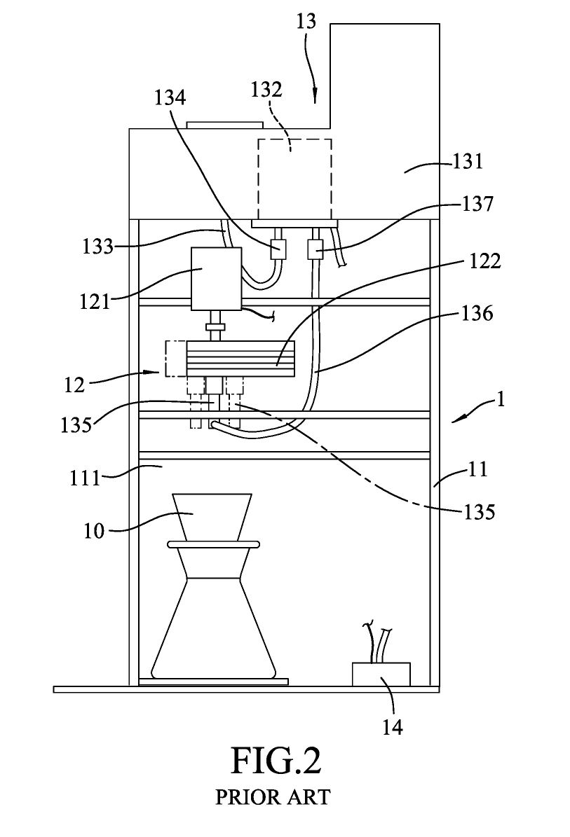

FIG. 3 is a partly exploded perspective view of an embodiment of a coffee machine according to the disclosure;

FIG. 4 is a schematic view illustrating operation of the embodiment;

FIG. 5 is a fragmentary exploded perspective view of a driving unit and a base of the embodiment;

FIG. 6 is a fragmentary partly sectional view of the embodiment when the coffee machine is at an initial state;

FIG. 7 is a fragmentary sectional top view of the embodiment when the coffee machine is at the initial state; and

FIG. 8 is a view similar to FIG. 7, but illustrating the coffee machine at a stopped state.

### DETAILED DESCRIPTION

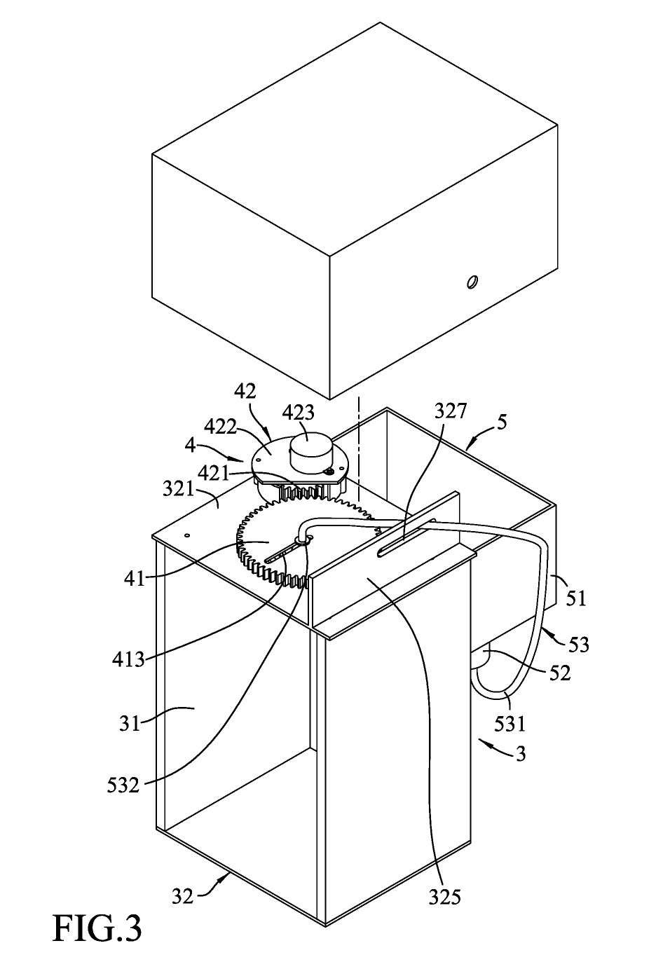

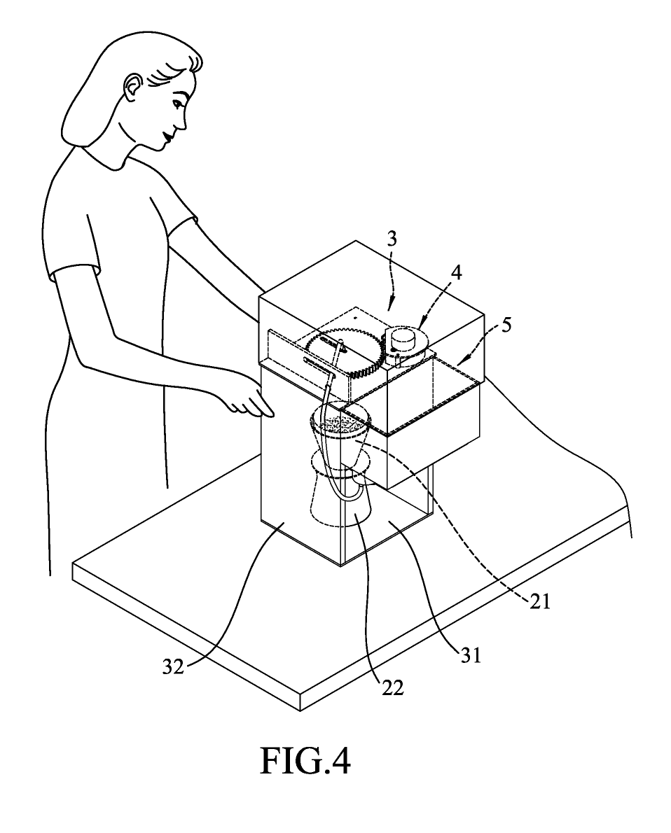

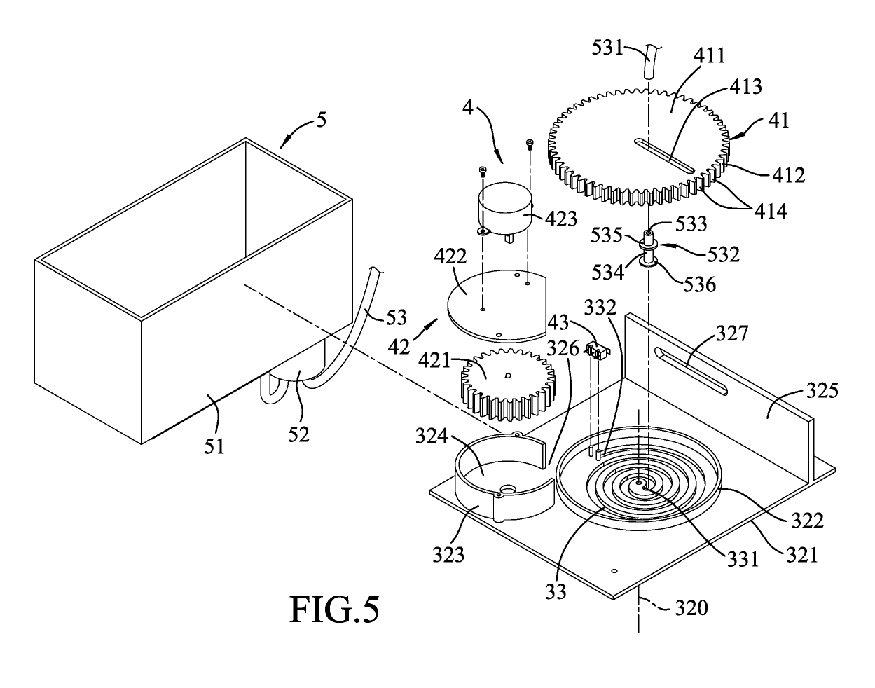

Referring to FIGS. 3 to 5, an embodiment of a coffee machine is configured to brew coffee from coffee powder. The coffee powder is disposed in a filter cup 21, and coffee is collected in a collecting pot 22 disposed under the filter cup 21. The coffee machine includes a base 3 that includes a frame 32 defining a receiving space 31 therein for accommodating the filter cup 21 and the collecting pot 22, and a driving unit 4 and a water supply unit 5 that are mounted on the base 3.

As shown in FIGS. 3, 5 and 6, the frame 32 has a guiding wall 321 located above the receiving space 31, a surrounding wall 322 extending from the guiding wall 321 and surrounding a rotational axis 320, a retaining wall 323 extending from the guiding wall 321, a gear-receiving space 324 defined by the retaining wall 323, and a hole-defining wall 325 extending from the guiding wall 321. The gear-receiving space 324 has an opening 326 adjacent to the surrounding wall 322 (i.e., the gear-receiving space 324 opens toward the surrounding wall 322). The hole-defining wall 325 is formed with a limiting hole 327. The frame 32 further has a spiral guiding groove 33 formed in the guiding wall 321 and winding around the rotational axis 320. The spiral guiding groove 33 is surrounded by the surrounding wall 322, and has a head end 331 adjacent to the rotational axis 320 and a tail end 332 opposite to the head end 331 and adjacent to the surrounding wall 322.

The driving unit 4 includes a transmission gear 41 rotatable about the rotational axis 320 and mounted to the base 3, a power unit 42 mounted to the base 3, and a control switch 43 mounted on the guiding wall 321 of the base 3 and adjacent to the tail end 332 of the spiral guiding groove 33. The transmission gear 41 has a main gear wall 411, and a side wall 412 extending from a periphery of the main gear wall 411 and surrounding the surrounding wall 322 of the frame 32. The main gear wall 411 is formed with a guiding hole 413 extending radially and outwardly from a center of the transmission gear 41 and disposed above the spiral guiding groove 33. The side wall 412 is formed with a plurality of equi-angularly spaced-apart teeth 414. In this embodiment, the power unit 42 includes a power gear 421 received in the gear-receiving space 324 of the base 3, a cover plate 422 disposed over and covering the gear-receiving space 324, and a power 423 mounted on the cover plate 422 for driving rotation of the power gear 421. The power gear 421 meshes with the teeth 414 of the side wall 412 of the transmission gear 41, and is rotatable to drive a rotation of the transmission gear 41 about the rotational axis 320. It should be noted that, in other embodiments, the method of driving the rotation of the transmission gear 41 may vary. For example, a driving belt may be provided to be trained on the transmission gear 41 and the power unit 42.

The water supply unit 5 includes a tank 51 connected to the base 3, a heater 52 disposed below and connected to the tank 51, and a water tube 53. The water tube 53 has a connecting section 531 connected to the heater 52 and extending through the limiting hole 327 of the frame 32, and a guiding section 532 connected to the connecting section 531, extending through the guiding hole 413 of the transmission gear 41 and the spiral guiding groove 33 of the frame 32, and being movable along the spiral guiding groove 33 under guidance of the guiding hole 413 during the rotation of the transmission gear 41 about the rotational axis 320. The guiding section 532 of the water tube 53 has a tube wall 534 defining an outlet channel 533, a first flange 535 extending outwardly from the tube wall 534 and located above the main gear wall 411 of the transmission gear 41, and a second flange 536 extending outwardly from the tube wall 534, spaced apart from the first flange 535, and located below the guiding wall 321 of the frame 32. With the design that the transmission gear 41 and the guiding wall 321 of the base 3 are disposed between the first and second flanges 535, 536, the transmission gear 41 and the guiding section 532 of the water tube 53 can be firmly mounted to the base 3, and the guiding section 532 of the water tube 53 can be smoothly movable along the spiral guiding groove 33.

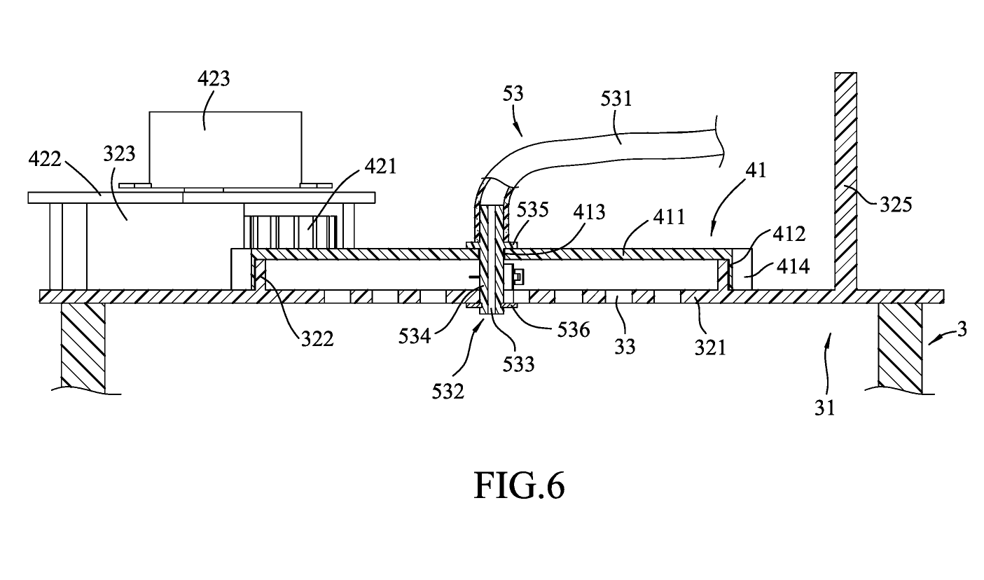

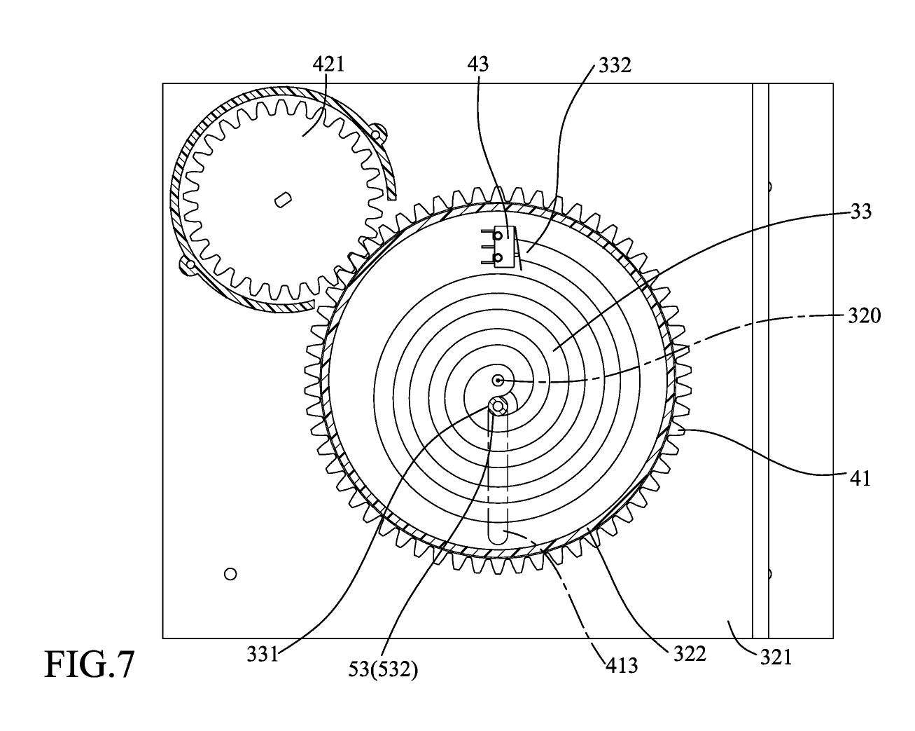

Referring to FIGS. 3, 6 and 7, in use, the heater 52 and the power 423 are controlled by a control circuit (not shown). Since the art of controlling the heater 52 and the power 423 is not the main object of the disclosure, detailed description thereof is omitted for the sake of brevity. Before the coffee-brewing process, as shown in FIGS. 6 and 7, the coffee machine is at an initial state, where the guiding section 532 of the water tube 53 is at the head end 331 of the spiral guiding groove 33. When the power 423 drives the rotation of the transmission gear 41 via the power gear 421, the guiding section 532 of the water tube 53 is driven to move along the spiral guiding groove 33 of the base 3 with the guidance of the guiding hole 413 of the transmission gear 41 toward the tail end 332 of the spiral guiding groove 33. At the same moment, water stored in the tank 51 flows to the heater 52 to be heated, then flows to the guiding section 532 through the connecting section 531, and finally flows out of the guiding section 532 to pour over the coffee powder for brewing coffee.

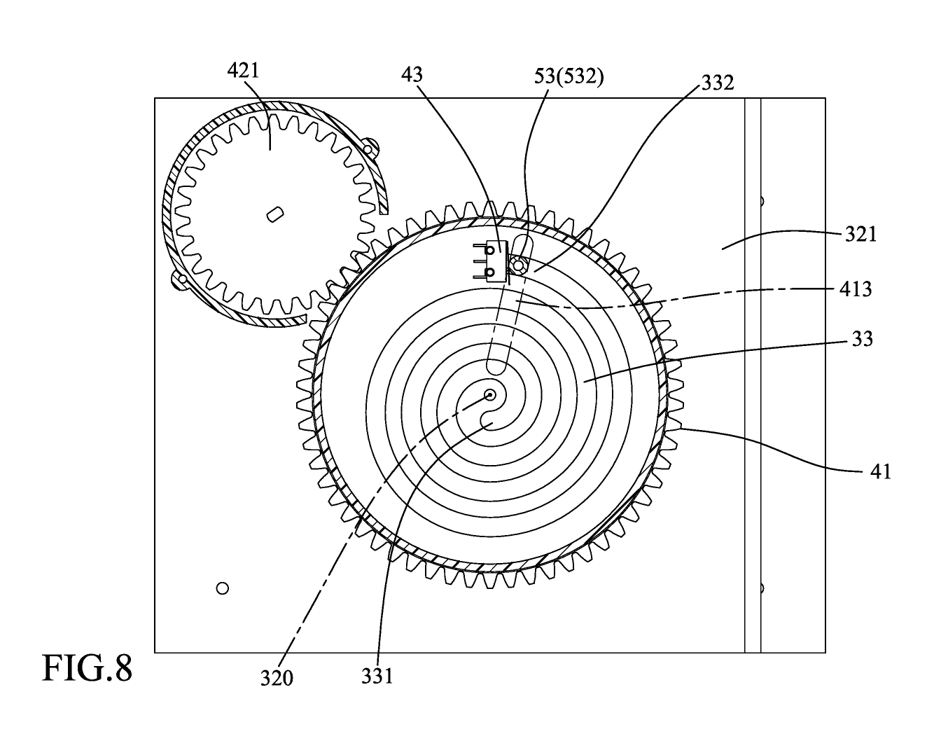

Referring to FIG. 8, when the guiding section 532 of the water tube 53 contacts the control switch 43, the coffee machine changes to a stopped state and the operation thereof is arrested. In other embodiments, the coffee machine may automatically return to the initial state by adjustment of the control circuit. In other words, a rotational direction of the power unit 42 may be reversed upon contact of the guiding section 532 of the water tube 53 to the control switch 43, so that the guiding section 532 of the water tube 53 can move reversely along the spiral guiding groove 33 and return to the head end 331 of spiral guiding groove 33 to await the next coffee-brewing process.

In conclusion, the coffee machine according to the disclosure has a simple structure, and most of the water tube 53 is received inside the base 3 with only a bottom portion of the guiding section 532 of the water tube 53 left under the guiding wall 321, so that the water tube 53 will not be interfered or scratched by surrounding elements of the coffee machine during operation. Moreover, since the connecting section 531 of the water tube 53 extends through and is restricted by the limiting hole 327, when the guiding section 532 moves along the spiral guiding groove 33, the connecting section 531 of the water tube 53 will not be tangled.

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A coffee machine comprising:
a base having
a guiding wall, and
a spiral guiding groove that is formed in said guiding wall and that winds around a rotational axis;
a driving unit including a transmission gear that is rotatable about the rotational axis, and that is formed with a guiding hole extending radially and outwardly from a center of said transmission gear and disposed above said spiral guiding groove; and
a water supply unit including a water tube that has a guiding section extending through said guiding hole and said spiral guiding groove, and being movable along said spiral guiding groove with the guidance of said guiding hole during rotation of said transmission gear about the rotational axis.

2. The coffee machine as claimed in claim 1, wherein said spiral guiding groove has a head end adjacent to the rotational axis, and a tail end opposite to said head end, said guiding section of said water tube being movable between said head end and said tail end of said spiral guiding groove.

3. The coffee machine as claimed in claim 2, wherein said driving unit further includes a power unit meshing with said transmission gear and rotatable to drive the rotation of said transmission gear, and a control switch controlling a rotational direction of said power unit, mounted on said guiding wall of said base and adjacent to said tail end of said spiral guiding groove.

4. The coffee machine as claimed in claim 1, wherein said base includes a frame having said guiding wall and defining a receiving space therein, said guiding wall being located above said receiving space.

5. The coffee machine as claimed in claim 4, wherein:
said frame of said base further has a surrounding wall extending from said guiding wall and surrounding said spiral guiding groove;
said transmission gear of said driving unit has a main gear wall formed with said guiding hole, and a side wall extending from a periphery of said main gear wall, surrounding said surrounding wall of said frame, and formed with a plurality of teeth; and
said driving unit further includes a power unit meshing with said teeth of said side wall of said transmission gear and rotatable to drive the rotation of said transmission gear.

6. The coffee machine as claimed in claim 4, wherein said water supply unit further includes a tank connected to said base, and a heater connected to said tank, said water tube further having a connecting section that is connected between said heater and said guiding section.

7. The coffee machine as claimed in claim 6, wherein said frame further has a hole-defining wall extending from said guiding wall and formed with a limiting hole, said connecting section of said water tube extending through said limiting hole.

8. The coffee machine as claimed in claim 1, wherein:
said transmission gear of said driving unit has a main gear wall formed with said guiding hole;
said guiding section of said water tube has a tube wall defining an outlet channel, and first and second flanges spaced apart from each other and extending outwardly from said tube wall; and
said main gear wall of said transmission gear and said guiding wall of said base are disposed between said first and second flanges.
